(19) United States
(12) Patent Application Publication
(10) Pub. No.: US 2026/0259042 A1
(43) Pub. Date: Sep. 3, 2026

(54) ASSEMBLY FIXTURE FOR VEHICLE WHEEL TOE ADJUSTMENT

(71) Applicant: Toyota Motor Engineering & Manufacturing North America, Inc., Plano, TX (US)

(72) Inventors: Trevor Raymond Lay, Cambridge (CA); Eric Andrew Wiles, Kitchener (CA); Tyler Brayden Monk, Cambridge (CA); Connor Earl Smith, Cambridge (CA); David Paul Grothen, Kitchener (CA)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/066,295

(22) Filed: Feb. 28, 2025

(51) Int. Cl. G01B 11/26; B62D 65/02

(52) U.S. Cl. CPC G01B 11/26; B62D 65/026

(57) ABSTRACT

A vehicle wheel toe adjustment block is structured to indicate a spacing required between a feature of a steering rack assembly inner tie rod positioned in the toe adjustment block and a jam nut mounted on the inner tie rod and abutting the adjustment block, to achieve an associated toe angle in an vehicle wheel coupled to the inner tie rod. The inner tie rod feature is aligned with an indicator mark formed on the toe adjustment block. The indicator mark is spaced apart from a bearing surface against which the jam nut is to be tightened. When the inner tie rod feature is aligned with the indicator mark and the jam nut is tightened against the bearing surface, the correct toe angle for a vehicle wheel may be achieved when the outer tie rod assembly is mounted on the inner tie rod and tightened against the jam nut.

### TECHNICAL FIELD

The present invention relates to assembly fixtures for vehicles and, more particularly, to an assembly fixture structured to enable a desired toe angle to be achieved in a vehicle wheel to be mounted to a steering rack.

### BACKGROUND

In a conventional steering rack assembly, a desired toe angle in a vehicle wheel may be provided by attaching an outer tie rod assembly (on which the wheel is to be mounted) to a threaded portion of an inner tie rod of the steering rack assembly. A jam nut may be applied to the inner tie rod at a location on the inner tie rod where the outer tie rod assembly is to be secured. Then, the outer tie rod assembly may be applied to the inner tie rod so as to abut the jam nut.

An ongoing problem is consistently positioning the jam nut on the inner tie rod in the position needed to provide the desired toe angle when the outer tie rod assembly and the associated vehicle wheel is attached to the inner tie rod.

### SUMMARY

In one aspect of the embodiments described herein, a vehicle wheel toe adjustment block is structured to indicate a spacing required between a reference feature of a steering rack assembly inner tie rod positioned in the toe adjustment block and a jam nut mounted on the inner tie rod and abutting the adjustment block, to achieve an associated predetermined toe angle in an vehicle wheel coupled to the inner tie rod.

### BRIEF DESCRIPTION OF THE DRAWINGS

The accompanying drawings, which are incorporated in and constitute a part of the specification, illustrate various systems, methods, and other embodiments of the disclosure. In some embodiments, one element may be designed as multiple elements or multiple elements may be designed as one element. In some embodiments, an element shown as an internal component of another element may be implemented as an external component and vice versa. Furthermore, elements may not be drawn to scale. Also, unless otherwise stated or shown, the same or similar elements shown in different views may be given the same or similar reference numerals or designations.

FIG. 1 is a schematic view of an assembly fixture including a toe adjustment assembly in accordance with an embodiment described herein, along with a steering rack assembly structured to be mounted in the toe adjustment assembly.

FIG. 1A is a schematic perspective view of a toe adjustment assembly in accordance with an embodiment described herein.

FIG. 2A is a schematic perspective view of a first toe adjustment block in accordance with an embodiment described herein.

FIG. 2B is a schematic plan view of the first toe adjustment block shown in FIG. 2A.

FIG. 2C is a schematic side view of the first toe adjustment block shown in FIG. 2A.

FIG. 3A is a schematic perspective view of a second toe adjustment block in accordance with an embodiment described herein.

FIG. 3B is a schematic plan view of the second toe adjustment block shown in FIG. 3A.

FIG. 3C is a schematic side view of the first toe adjustment block shown in FIG. 3A.

FIG. 4A is a plan perspective view of a first end of the assembly fixture of FIG. 1 showing a first inner tie rod of the steering rack assembly positioned in a slot of the first toe adjustment block with an associated first jam nut applied to an end of the tie rod at a position associated with a desired toe angle of an associated first road wheel to be attached to the steering rack assembly.

FIG. 4B is the plan perspective view of FIG. 4A showing attachment of a first outer tie rod assembly to the first inner tie rod abutting the first jam nut.

FIG. 5A is a plan perspective view of a second end of the assembly fixture of FIG. 1 showing a second inner tie rod of the steering rack assembly positioned in a slot of the second toe adjustment block with an associated second jam nut applied to an end of the tie rod at a position associated with a desired toe angle of an associated second road wheel to be attached to the steering rack assembly.

FIG. 5B is the plan perspective view of FIG. 5A showing attachment of a second outer tie rod assembly to the second inner tie rod abutting the second jam nut.

### DETAILED DESCRIPTION

A vehicle wheel toe adjustment block is structured to indicate a spacing required between a reference feature of a steering rack assembly inner tie rod positioned in the toe adjustment block and a jam nut mounted on the inner tie rod and abutting the adjustment block, to achieve an associated predetermined toe angle in an vehicle wheel coupled to the inner tie rod. The reference feature of the inner tie rod is aligned with an indicator mark formed on the toe adjustment block. For purposes described herein, a reference feature of an inner tie rod is aligned with an indicator mark formed on an associated toe adjustment block when the reference feature is aligned with a specific visible physical characteristic (e.g. an edge) of the indicator mark. The indicator mark is spaced apart from a bearing surface against which the jam nut is to be tightened. When the reference feature of the inner tie rod is aligned with the indicator mark and the jam nut is tightened against the toe adjustment block bearing surface, the correct toe angle for an associated vehicle wheel may be achieved when the outer tie rod assembly is mounted on the inner tie rod and tightened against the jam nut. A toe adjustment assembly including the vehicle wheel toe adjustment block is also described.

The various elements set forth in the following description may be fabricated from any material or materials (e.g., metals, polymers, etc.) suitable for the purposes described herein.

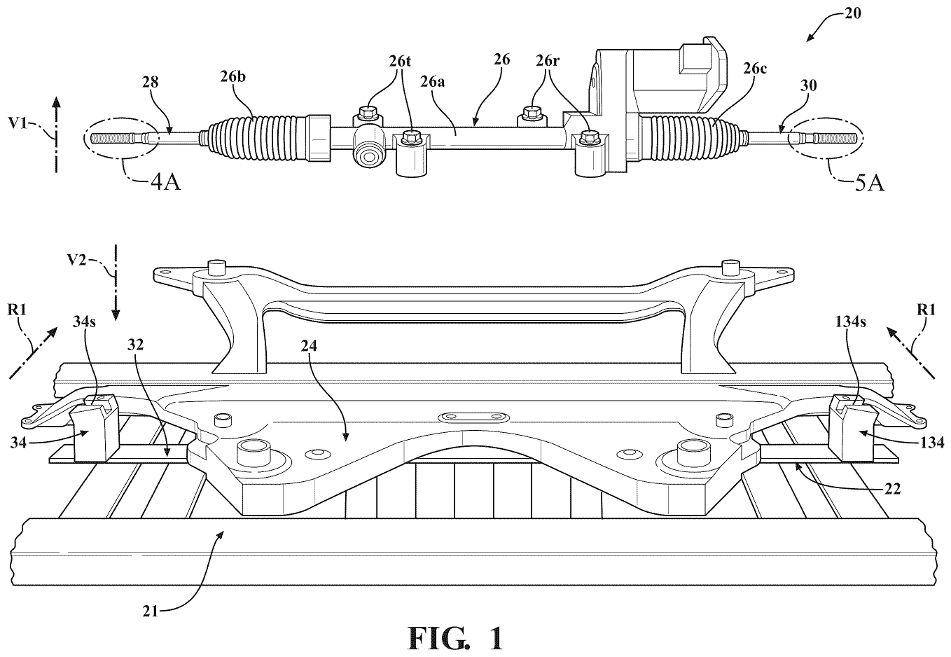

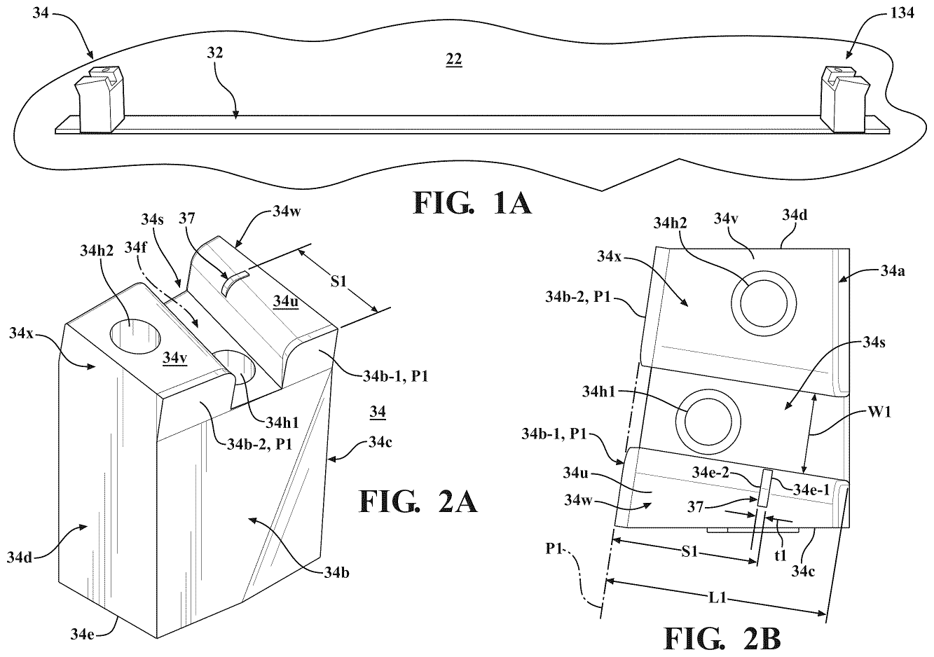

FIG. 1 is a schematic view of an assembly fixture 20 including a toe adjustment assembly in accordance with an embodiment described herein. The assembly fixture 20 may be directed to assembling outer tie rod assemblies to a steering rack assembly so that a desired predetermined toe angle is provided in each vehicle road wheel attached to the steering rack assembly.

The assembly fixture 20 may include an assembly pallet 21 to serve as a base for operations performed to complete fabrication of the steering rack assembly as described herein. The assembly pallet 21 may be positioned atop a frame or table (not shown) to elevate the pallet 21 above floor level, if needed.

A toe adjustment assembly 22 (as described in greater detail below) may be secured to a working surface 21w of the assembly pallet 21 prior to securement of an H-frame 24 to the assembly pallet 21.

A vehicle H-frame or sub frame 24 may be mounted on the assembly pallet 21 over the toe adjustment assembly 22. The H-frame 24 may be structured for attachment of a steering rack assembly 26 thereto. The H-frame 24 and connected steering rack assembly 26 may form a sub-assembly to be incorporated into a steering system of a vehicle (not shown). The H-frame 24 may be positioned on the assembly pallet 21 relative to the toe adjustment assembly 22 so that, when the steering rack assembly 26 is connected to the H-frame 24, an inner tie rod extending from each end of the steering rack assembly 26 will be positioned (or positionable) in a slot formed in a respective toe adjustment block of the toe adjustment assembly 22, as described herein.

A conventionally-configured steering rack assembly 26 may connected to the H-frame 24 by bolted connections at locations 26t, 26r. In one or more arrangements, the steering rack assembly 26 may generally include a body portion 26a having a first end 26b and a second end 26c opposite the first end 26b. A first inner tie rod 28 may be coupled to the body portion first end 26b. A second inner tie rod 30 may be coupled to the body portion second end 26c. In one or more arrangements, the inner tie rods 28, 30 seen in FIG. 1 may extend rearwardly and downwardly from their respective ends 26b, 26c of the steering rack assembly body portion 26a when the steering rack assembly 26 is secured to the H-frame 24.

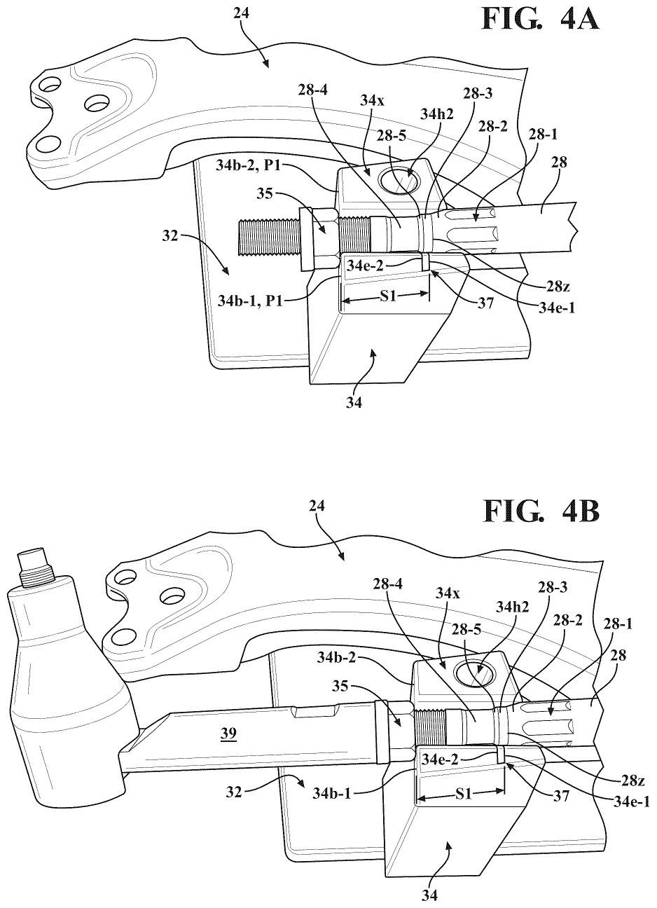

Referring to FIGS. 4A and 4B, part of the first inner tie rod 28 extending from the steering rack assembly body portion 26a into slot 34s may include a polygonal region 28-1 formed from a plurality of intersecting adjacent flat sides. For example, polygonal region 28-1 may be octagonal. The first inner tie rod 28 may taper down along a conical region 28-2 extending from an end of the polygonal region 28-1 toward the end of the first inner tie rod 28 to terminate in a cylindrical region 28-3 having an outer diameter less than a maximum outer diameter of the polygonal region 28-1. The cylindrical region 28-3 may extend from the conical region 28-2 to a substantially orthogonal shoulder 28-5 providing a transition between the cylindrical region 28-3 and another cylindrical region 28-4 having an outer diameter less than the outer diameter of the cylindrical region 28-3.

In one or more arrangements, a line on the first inner tie rod 28 where the conical region 28-2 and the cylindrical region 28-3 intersect may form a reference feature 28z structured to be aligned with an indicator mark 37 of an associated first toe adjustment block 34 during fabrication of the steering rack assembly 26 as described herein, to achieve a desired wheel toe angle.

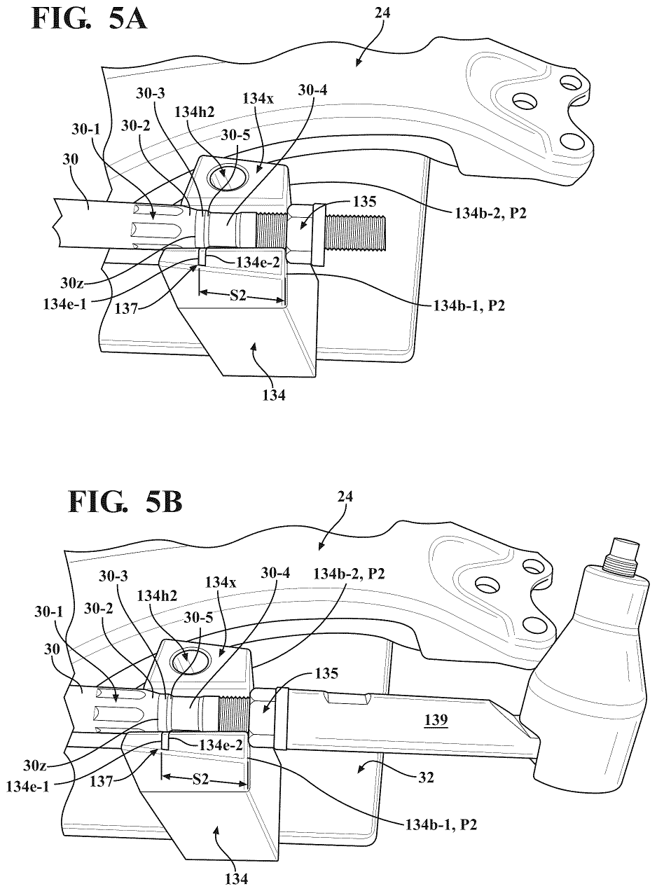

Referring to FIGS. 5A and 5B, part of the second inner tie rod 30 extending from the steering rack assembly body portion 26a into slot 134s may include a polygonal region 30-1 formed from a plurality of intersecting adjacent flat sides. For example, polygonal region 30-1 may be octagonal. The second inner tie rod 30 may taper down along a conical region 30-2 extending from an end of the polygonal region 30-1 toward the end of the second inner tie rod 30 to terminate in a cylindrical region 30-3 having an outer diameter less than a maximum outer diameter of the polygonal region 30-1. The cylindrical region 30-3 may extend from the conical region 30-2 to a substantially orthogonal shoulder 30-5 providing a transition between the cylindrical region 30-3 and another cylindrical region 30-4 having an outer diameter less than the outer diameter of the cylindrical region 30-3.

In one or more arrangements, a line on the second inner tie rod 30 where the conical region 30-2 and the cylindrical region 30-3 intersect may form a reference feature 30z structured to be aligned with an indicator mark 137 of an associated second toe adjustment block 134 during fabrication of the steering rack assembly 26 as described herein, to achieve a desired wheel toe angle.

As used herein, terms such as “upper”, “lower” “downward”, “upward”, “rearward”, etc. are with reference to the arrangement shown in FIG. 1, with the assembly pallet 21 residing on a table or floor surface, the toe adjustment assembly 22 residing on an upwardly facing working surface 21w of the assembly pallet 21, the H-frame mounted 24 on the assembly pallet working surface 21w as described herein, and the steering rack assembly 26 connected to the H-frame 24 in a manner described herein. For example, in FIG. 1, arrow V1 may indicate an upward direction, arrow V2 may indicate a downward direction, and an arrow R1 may indicate a rearward direction (i.e., generally into a plane of the drawing).

In arrangements described herein, the toe adjustment assembly 22 may be structured to facilitate positioning of a jam nut along each inner tie rod of a steering rack assembly mounted on the toe adjustment assembly, so as to provide a respective predetermined toe angle in a vehicle wheel subsequently coupled to a respective one of the inner tie rods.

Referring to FIGS. 1 and 1A, the toe adjustment assembly 22 may include a base 32 structured for attachment to the assembly pallet 21. The base 32 may be formed from an elongated strip of steel, aluminum or another material suitable for the purposes described herein.

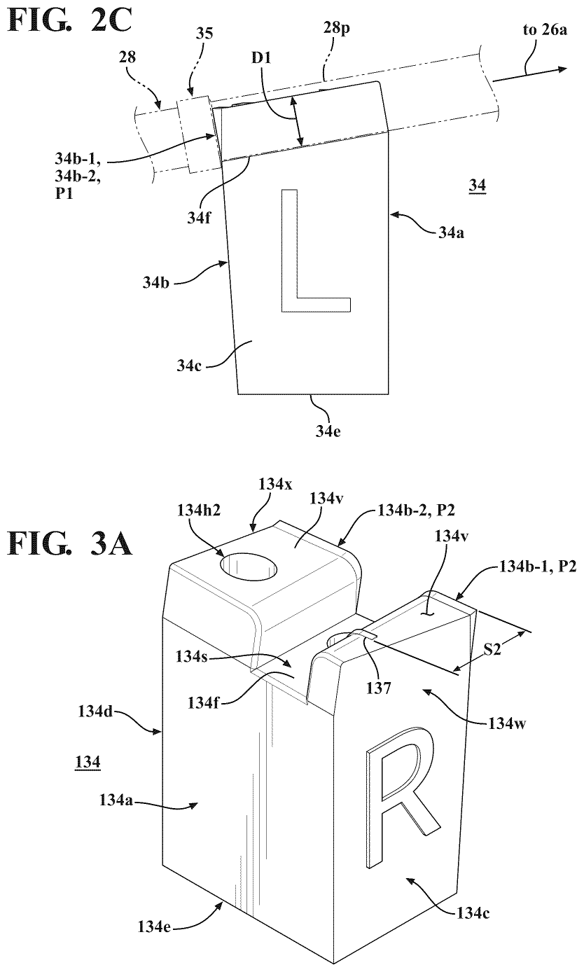

Referring to FIGS. 1-2C, the toe adjustment assembly 22 may also include a first toe adjustment block 34 fixedly secured to the base 32. The first toe adjustment block 34 may include a first face 34a structured to face in a direction generally toward the body portion 26a of the steering rack assembly 26 when the first toe adjustment block 34 is secured to the base 32 and the steering rack assembly 26 is mounted in the toe adjustment assembly 22. the steering rack assembly 26 is considered to be mounted in the toe adjustment assembly 22 when a portion of first inner tie rod 28 of the steering rack assembly 26 is received in a slot 34s (described in greater detail below) of the first toe adjustment block 34 of the toe adjustment assembly 22, and a portion of the second inner tie rod 30 of the steering rack assembly 26 is received in a slot 134s of a second toe adjustment block 134 of the toe adjustment assembly 22, as described herein.

The first toe adjustment block 34 may also include a second face 34b positioned opposite the first face 34a. the first toe adjustment block 34 may also include a third face 34c extending between the first and second faces 34a, 34b and a fourth face 34d extending opposite the third face 34c (i.e., rearwardly of the third face 34c) and between the first and second faces 34a, 34b.

A flat attachment surface 34e may extend between the first and second faces 34a, 34b and between the third and fourth faces 34c, 34d. The first toe adjustment block 34 may be attached to the base 32 along the attachment surface 34e.

Referring to FIGS. 2A-2C, a slot 34s may extend between the first toe adjustment block first and second faces 34a, 34b and may be structured to receive therein a portion of a respective inner tie rod (e.g., first inner tie rod 28) of the steering rack assembly 26 when the steering rack assembly is mounted in the toe adjustment assembly 22. The slot 34s may be structured to open upwardly as shown in FIG. 1 when the first toe adjustment block 34 is secured in the toe adjustment assembly 22.

In one or more arrangements, the slot 34s may have a uniform width dimension W1 along its length dimension L1. In one or more arrangements, the slot 34s may have a uniform depth D1 along its length dimension L1.

Referring to FIGS. 2A-2C, in one or more arrangements, the slot 34s may have a bottom 34f structured to slope in a direction toward the attachment surface 34e when proceeding in a direction leading from the first face 34a toward the second face 34b. this downward slope of the slot 34s may be structured to accommodate the downwardly sloping aspect of the first inner tie rod 28 as it extends from the steering rack assembly body portion 26a, so that the first inner tie rod 28 is in contact with the slot bottom 34f when the first toe adjustment block 34 is secured in a toe adjustment assembly 22 attached to the assembly pallet 21 as shown in FIG. 1, the steering rack assembly 26 is secured to the H-frame 24, and the first inner tie rod 28 is positioned in the slot 34s.

In addition, portions 34b-1 and 34b-2 of the block second face 34b adjacent the slot 34s may define jam nut bearing surfaces structured to extend perpendicular to the slot bottom 34f. This may enable a jam nut 35 positioned along the first inner tie rod 28 to be tightened against the bearing surfaces 34b-1 and 34b-2 when the portion 28p of first inner tie rod 28 is received in the slot 34s. The portions 34b-1 and 34b-2 of the second face 34b defining the jam nut bearing surfaces may be coplanar. FIG. 2C is a side view of the first toe adjustment block 34 showing a portion 28p of a first inner tie rod 28 (in phantom) extending through the slot 34s with the tie rod 28 in contact with the slot bottom 34f, and with a jam nut 35 tightened against the jam nut bearing surfaces 34b-1 and 34b-2.

Referring to FIGS. 2A-2C, in one or more arrangements, the slot 34s is structured to angle in a direction extending from the third face 34c toward the fourth face 34d when proceeding in a direction leading from the first face 34a toward the second face 34b. this rearward angling of the slot 34s may be structured to accommodate the rearwardly angling aspect of the first inner tie rod 28 as it extends from an associated end of the steering rack assembly body portion 26a, when the first toe adjustment block 34 is secured in a toe adjustment assembly 22 attached to the assembly pallet 21 as shown in FIG. 1, the steering rack assembly 26 is secured to the H-frame 24, and the first inner tie rod 28 is positioned in the slot 34s.

In one or more arrangements, a pair of opposed walls 34w and 34x may extend along opposite sides of the slot 34s. A first wall 34w may have a first upwardly-facing surface 34u positioned opposite the attachment surface 34e, and a second wall 34x may have a second upwardly-facing surface 34v positioned opposite the attachment surface 34e. The surfaces 34u and 34v may be coplanar.

An indicator mark 37 may be positioned along the first upwardly-facing surface 34u and along an edge 34s-1 of the slot, so that the indicator mark 37 is visible to user when the portion of the first inner tie rod 28 is positioned in the slot 34s. The indicator mark 37 may have a predetermined width or thickness t1 specified to enhance visibility of the mark. The mark 37 may have a first edge 34e-1 and a second edge 34e-2 spaced apart the distance t1 from first edge 34e-1 and extending parallel to first edge 34e-1. In addition, the indicator mark first edge 34e-1 may be spaced apart a predetermined distance S1 from a plane P1 defined by the jam nut bearing surfaces 34b-1 and 34b-2. The indicator mark first edge 34e-1 may be positioned so as to indicate a spacing required, between a reference feature 28z of the portion 28p of the first inner tie rod 28 positioned in the first toe adjustment block 34 and the jam nut 35 mounted on the first inner tie rod 28 and abutting the block 34, to achieve an associated predetermined toe angle in an vehicle wheel coupled to the first inner tie rod 28.

In one or more arrangements, a through hole 34h1 may be provided in the slot bottom 34f to enable the first toe adjustment block 34 to be attached to the base 32, using a bolt or other suitable fastener. Also, another through hole 34h2 may be provided in the second upwardly-facing surface 34v to enable the first toe adjustment block 34 to be attached to the base 32, using a bolt or other suitable fastener.

After the jam nut 35 is tightened to its desired location along the first inner tie rod 28, the first outer tie rod assembly 39 may be applied to the first inner tie rod 28 and tightened against the jam nut 35. The vehicle wheel (not shown) may then be connected to the first outer tie rod assembly 39.

Referring again to FIGS. 2A-2C, the distance S1 may be associated with the desired predetermined toe angle to be imparted to the vehicle wheel coupled to the first side of the steering rack assembly 26. For example, to provide more of a “toe-in” condition in the assembled vehicle wheel, the first toe adjustment block 34 may be fabricated so that the distance S1 is relatively shorter. This may result in the first outer tie rod assembly 39 being relatively closer to the steering rack assembly body portion 26a (and, therefore, relatively closer to a longitudinal centerline of the vehicle) when the first outer tie rod assembly 39 is tightened against the jam nut 35 which abuts the toe adjustment block second face 34b. Alternatively, to provide more of a “toe-out” condition in the assembled vehicle wheel, the first toe adjustment block 34 may be fabricated so that the distance S1 is relatively larger. This may result in the first outer tie rod assembly 39 being relatively farther from the steering rack assembly body portion 26a (and, therefore, relatively farther from the longitudinal centerline of the vehicle) when the first outer tie rod assembly 39 is tightened against the jam nut 35 which abuts the toe adjustment block second face 34b.

Referring to FIGS. 1,1A and 3A-3C, the toe adjustment assembly 22 may also include a second toe adjustment block 134 fixedly secured to the base 32. The second toe adjustment block 134 may include a first face 134a structured to face in a direction generally toward the body portion 26a of the steering rack assembly 26 when the second toe adjustment block 134 is secured to the base 32 and the steering rack assembly 26 is mounted in the toe adjustment assembly 22. The second toe adjustment block 134 may also include a second face 134b positioned opposite the first face 134a. the second toe adjustment block 134 may also include a third face 134c extending between the first and second faces 134a, 134b and a fourth face 134d extending opposite the third face 134c (i.e., rearwardly of the third face 134c) and between the first and second faces 134a, 134b. A flat attachment surface 134e may extend between the first and second faces 134a, 134b and between the third and fourth faces 134c, 134d. The second toe adjustment block 134 may be attached to the base 32 along the attachment surface 134e.

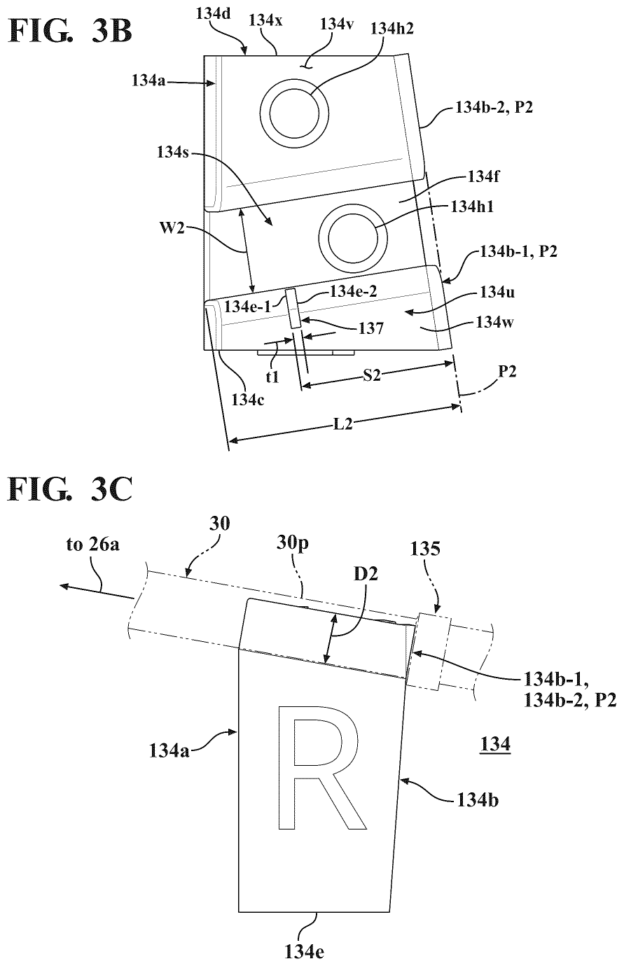

Referring to FIGS. 3A-3C, a slot 134s may extend between the first toe adjustment block first and second faces 134a, 134b and may be structured to receive therein a portion of a respective inner tie rod (e.g., second inner tie rod 30) of the steering rack assembly 26 when the steering rack assembly is mounted in the toe adjustment assembly 22. The slot 134s may be structured to open upwardly as shown in FIG. 1 when the second toe adjustment block 134 is secured in the toe adjustment assembly 22.

In one or more arrangements, the slot 134s may have a uniform width dimension W2 along its length dimension L2. In one or more arrangements, the slot 134s may have a uniform depth D2 along its length dimension L2.

Referring to FIGS. 3A-3C, in one or more arrangements, the slot 134s may have a bottom 134f structured to slope in a direction toward the attachment surface 134e when proceeding in a direction leading from the first face 134a toward the second face 134b. This downward slope of the slot 134s may be structured to accommodate the downwardly sloping aspect of the second inner tie rod 30 as it extends from the steering rack assembly body portion 26a, so that the first inner tie rod 28 is in contact with the slot bottom 134f when the second toe adjustment block 134 is secured in a toe adjustment assembly 22 attached to the assembly pallet 21 as shown in FIG. 1, the steering rack assembly 26 is secured to the H-frame 24, and the second inner tie rod 30 is positioned in the slot 134s.

In addition, portions 134b-1 and 134b-2 of the block second face 134b adjacent the slot 134s may define jam nut bearing surfaces structured to extend perpendicular to the slot bottom 134f. This may enable a jam nut 135 positioned along the second inner tie rod 30 to be tightened against the bearing surfaces 134b-1 and 134b-2 when the portion 30p of second inner tie rod 30 is received in the slot 134s. The portions 134b-1 and 134b-2 of the second face 134b defining the jam nut bearing surfaces may be coplanar. FIG. 3C is a side view of the second toe adjustment block 134 showing a portion 30p of the second inner tie rod 30 (in phantom) extending through the slot 134s with the tie rod 30 in contact with the slot bottom 134f, and with a jam nut 135 tightened against the jam nut bearing surfaces 134b-1 and 134b-2.

Referring to FIGS. 3A-3C, in one or more arrangements, the slot 134s is structured to angle in a direction extending from the third face 134c toward the fourth face 134d when proceeding in a direction leading from the first face 134a toward the second face 134b. this rearward angling of the slot 134s may be structured to accommodate the rearwardly angling aspect of the second inner tie rod 30 as it extends from an associated end of the steering rack assembly body portion 26a, when the second toe adjustment block 134 is secured in a toe adjustment assembly 22 attached to the assembly pallet 21 as shown in FIG. 1, the steering rack assembly 26 is secured to the H-frame 24, and the second inner tie rod 30 is positioned in the slot 134s.

In one or more arrangements, a pair of opposed walls 134w and 134x may extend along opposite sides of the slot 134s. A first wall 134w may have a first upwardly-facing surface 134u positioned opposite the attachment surface 134e, and a second wall 134x may have a second upwardly-facing surface 134v positioned opposite the attachment surface 134e. The surfaces 134u and 134v may be coplanar.

An indicator mark 137 may be positioned along the first upwardly-facing surface 134u and along an edge 134s-1 of the slot, so that the indicator mark 137 is visible to user when the portion of the second inner tie rod 30 is positioned in the slot 134s. The indicator mark 137 may have a predetermined width or thickness t1 specified to enhance visibility of the mark. The mark 137 may have a first edge 134e-1 and a second edge 134e-2 spaced apart the distance t1 from first edge 134e-1 and extending parallel to first edge 134e-1. In addition, the indicator mark first edge 134e-1 may be spaced apart a predetermined distance S2 from a plane P2 defined by the jam nut bearing surfaces 134b-1 and 134b-2. The indicator mark 137 may be positioned so as to indicate a spacing required, between a reference feature 30z of the portion 30p of the second inner tie rod 30 positioned in the second toe adjustment block 134 and the jam nut 135 mounted on the second inner tie rod 30 and abutting the block 134, to achieve an associated predetermined toe angle in an vehicle wheel coupled to the second inner tie rod 30.

In one or more arrangements, a through hole 134h1 may be provided in the slot bottom 134f to enable the second toe adjustment block 134 to be attached to the base 32, using a bolt or other suitable fastener. Also, another through hole 134h2 may be provided in the second upwardly-facing surface 134v to enable the second toe adjustment block 134 to be attached to the base 32, using a bolt or other suitable fastener.

After the jam nut 135 is tightened to its desired location along the second inner tie rod 30, the second outer tie rod assembly 139 may be applied to the second inner tie rod 30 and tightened against the jam nut 135. The vehicle wheel (not shown) may then be connected to the second outer tie rod assembly 139.

Referring again to FIGS. 3A-3C, the distance S2 may be associated with the desired predetermined toe angle to be imparted to the vehicle wheel coupled to the first side of the steering rack assembly 26. For example, to provide more of a “toe-in” condition in the assembled vehicle wheel, the second toe adjustment block 134 may be fabricated so that the distance S2 is relatively shorter. This may result in the second outer tie rod assembly 139 being relatively closer to the steering rack assembly body portion 26a (and, therefore, relatively closer to a longitudinal centerline of the vehicle) when the second outer tie rod assembly 139 is tightened against the jam nut 135 which abuts the toe adjustment block second face 134b. Alternatively, to provide more of a “toe-out” condition in the assembled vehicle wheel, the second toe adjustment block 134 may be fabricated so that the distance S2 is relatively larger. This may result in the second outer tie rod assembly 139 being relatively farther from the steering rack assembly body portion 26a (and, therefore, relatively farther from the longitudinal centerline of the vehicle) when the second outer tie rod assembly 139 is tightened against the jam nut 135 which abuts the toe adjustment block second face 134b.

To provide a different toe angle to a vehicle wheel to be attached to the steering rack assembly, a respective toe adjustment block along the pertinent end of the steering rack assembly may be replaced in the toe adjustment assembly by attaching a replacement block with a different spacing S1 or S2. In one or more arrangements, the spacings S1 and S2 (of the first and second toe adjustment blocks 34, 134, respectively) may be equal to provide the same toe angle to each vehicle wheel coupled to the steering rack assembly. In one or more other arrangements, the spacings S1 and S2 may be different to provide respective different toe angles to each vehicle wheel coupled to the steering rack assembly.

Referring to FIG. 1A, to fabricate the toe adjustment assembly 20, a base 32 of the toe adjustment assembly without the toe adjustment blocks 34, 134 attached may be secured to the assembly pallet 21 as previously described. A suitable H-frame 24 may then be mounted on the assembly pallet 21 over the base 32 as previously described. A “calibration” steering rack assembly 26 may then be mounted on the H-frame 24 as previously described. A first toe adjustment block 34 structured to provide a predetermined toe angle for a first wheel to be coupled to the respective end of the steering rack assembly 26 may then be positioned along the first inner tie rod 28 so that the indicator mark first edge 34e-1 on the toe adjustment block 34 aligns with the prescribed reference feature 28z on the first inner tie rod 28. The first toe adjustment block 34 may then be secured in this position on the base 32. A second toe adjustment block 134 structured to provide a predetermined toe angle for a second wheel to be coupled to the opposite end of the steering rack assembly 26 may then be positioned along the second inner tie rod 30 so that the indicator mark first edge 134e-1 on the toe adjustment block 134 aligns with the prescribed reference feature 30z on the second inner tie rod 30. The second toe adjustment block 134 may then be secured in this position on the base 32 to provide the toe adjustment assembly 22.

In a new steering rack assembly that will have the same toe angles as the calibration steering rack assembly rack assembly described above, the new steering rack assembly may be positioned in the toe adjustment assembly 22. In the new steering rack assembly, the indicators marks on the toe adjustment blocks 34, 134 at the ends of the toe adjustment assembly 22 will then automatically align with respective prescribed reference features on the inner tie rods as previously described. A jam nut can then be applied to each inner tie rod and tightened against a respective bearing surface of each toe adjustment block as previously described, to provide a location for tightening a respective outer tie rod assembly against each jam nut, as previously described.

In the manner described above, the toe adjustment assembly 22 may be used to consistently indicate a location on an inner tie rod at which a respective outer tie rod assembly is to be secured in order to provide a desired wheel toe angle.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . .” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A vehicle wheel toe adjustment block structured to indicate a spacing required between a reference feature of a steering rack assembly inner tie rod positioned in the toe adjustment block and a jam nut mounted on the inner tie rod and abutting the adjustment block, to achieve an associated predetermined toe angle in an vehicle wheel coupled to the inner tie rod.

2. The toe adjustment block of claim 1, further comprising:
a first face;
a second face opposite the first face;
a slot extending between the first and second faces and structured to receive therein a portion of the inner tie rod; and
an indicator mark positioned along an edge of the slot and spaced apart the required spacing from the second face.

3. The toe adjustment block of claim 2, wherein a portion of the second face defines a jam nut bearing surface extending adjacent the slot and perpendicular to a bottom of the slot, and wherein the an indicator mark is positioned spaced apart the required spacing from the bearing surface.

4. The toe adjustment block of claim 2, further comprising a flat attachment surface connecting the first and second faces, wherein the slot has a bottom structured to slope in a direction toward the attachment surface when proceeding in a direction leading from the first face toward the second face.

5. The toe adjustment block of claim 2, further comprising:
a third face extending between the first and second faces; and
a fourth face extending opposite the third face and between the first and second faces,
wherein the slot is structured to angle in a direction extending from the third face toward the fourth face when proceeding in a direction leading from the first face toward the second face.

6. The toe adjustment block of claim 2, wherein the slot is structured so that the inner tie rod abuts a bottom of the slot when the inner tie rod is positioned in the slot.

7. A toe adjustment assembly comprising a vehicle wheel toe adjustment block in accordance with claim 1.

8. A toe adjustment assembly structured to facilitate positioning of a jam nut along each inner tie rod of a steering rack assembly mounted on the toe adjustment assembly, so as to provide a respective predetermined toe angle in a vehicle wheel subsequently coupled to a respective inner tie rod, the assembly comprising:
a base;
a first toe adjustment block secured to the base; and
a second toe adjustment block secured to the base spaced apart from the first toe adjustment block.

9. The toe adjustment assembly of claim 8, wherein each toe adjustment block includes:
a first face;
a second face opposite the first face;
a slot extending between the first and second faces and structured to receive therein a portion of a respective inner tie rod of the steering rack assembly; and
an indicator mark positioned along an edge of the slot so as to be aligned with a reference feature on a respective inner tie rod when the steering rack assembly is mounted on the toe adjustment assembly.

10. The toe adjustment assembly of claim 9, wherein each toe adjustment block slot has a respective bottom, wherein each block second face defines a respective jam nut bearing surface extending adjacent a respective slot of the block and perpendicular to the respective slot bottom, and wherein a respective indicator mark is positioned spaced apart from the respective bearing surface a distance associated with the predetermined toe angle.
